(19) United States
(12) Patent Application Publication
(10) Pub. No.: US 2003/0235488 A1
(43) Pub. Date: Dec. 25, 2003

(54) Deployable wheel pallet system

(75) Inventor: Nir Hadar, Shefayim (IL)

Correspondence Address: DR. MARK FRIEDMAN LTD., C/o Bill Polkinghorn, Discovery Dispatch, 9003 Florin Way, Upper Marlboro, MD, 20772, US

(73) Assignee: POLYMER LOGISTICS

(21) Appl. No.: 10/176,150

(22) Filed: Jun. 21, 2002

(51) Int. Cl. B60P 1/02

(52) U.S. Cl. 414/495

(57) ABSTRACT

The present invention is a pallet system that includes a plurality of deployable-wheel pallets for use with a specialized pallet dolly. The pallets are configured to be lifted from the ground and supported at one end by deployable wheels located in the pallet support pillars and at the other end of the pallet by the wheeled dolly. Once supported, the pallet may be moved as desired. The pallet is then lowered to the ground and the dolly removed for use with another such pallet.

### FIELD AND BACKGROUND OF THE INVENTION

The present invention relates to shipping pallets and, in particular, it concerns a pallet system that includes a plurality of deployable wheel pallets for use with a specialized pallet dolly.

The use of hand trucks or pallet dollies for use in re-locating shipping pallets is well known in the art. One of the earlier patents in the art is U.S. Pat. No. 1,115,796 to Fahnestock, which discloses a three-wheeled hand truck that is narrow enough to fit under a standard shipping pallet. The hand truck has a platform that is mechanically raised and lowered by the handle which acts a lever.

The state of the art, as represented by U.S. Pat. Nos. 3,701,211 to Best and 4,378,191 to Sato, has advanced little from the Fahnestock device, in that all of the support structure and all of the wheels upon which the pallet is transported are integral to the dolly. This is due in part to a limitation of designing around existing standard shipping pallets. This design limitation results in redundancy of support structures and the scope of improvement in the art.

The standard size of shipping pallet also presents some problems for end users. In some commercial environments, a standard pallet and dolly are too large. The size may hamper ease of maneuverability or completely restrict access.

There is therefore a need for a pallet system in which the support structure and rollers or wheels are divided between the pallet and the dolly, thus substantially reducing structural redundancy. It would be desirable for the pallets to be of a size that is easily maneuverable in areas with limited access. It would be further desirable if the major components of the pallet system were formed of polymer materials.

### SUMMARY OF THE INVENTION

The present invention is a pallet system that includes a plurality of deployable wheel pallets for use with a specialized pallet dolly.

According to the teachings of the present invention there is provided, A pallet system for relocating any of at least one of interchangeable pallets by use of a specialized pallet dolly, the system comprising: at least one pallet that includes a wheel deployment mechanism, the wheel deployment mechanism configured to deploy at least one deployable wheel from a non-support position to a support position, the deployable wheel being located in a wheeled region of the pallet; and at least one pallet dolly configured so as to be deployable under at least a portion of the pallet, the dolly being detachably connectable to the pallet, the pallet dolly including a pallet lifting and support element and an actuation mechanism, the actuation mechanism configured to releasably engage and actuate the wheel deployment mechanism, thereby deploying the deployable wheel to a support position, the pallet lifting and support element configured so as to lift and support a non-wheeled region of the pallet; wherein once so deployed, the pallet is supported by wheels and may then be re-located as necessary, the deployable wheel returned to a non-support position, the pallet lifting and support element disengaged from the pallet, and the dolly disengaged from the wheel deployment mechanism, thereby allowing redeployment of the dolly for use with another such pallet.

According to a further teaching of the present invention, the actuation mechanism is configured to be activated by varying a position of a dolly handle.

According to a further teaching of the present invention, the wheel deployment mechanism and the pallet lifting and support element are configured to be activated by a single activating element such that respective portions of the pallet are raised simultaneously.

According to a further teaching of the present invention, the wheel deployment mechanism is mechanical.

According to a further teaching of the present invention, the wheel deployment mechanism is hydraulic.

According to a further teaching of the present invention, the pallet is formed of polymer materials.

There is provided according to a further teaching of the present invention, a method for relocating a pallet, the method comprising: providing a pallet that includes a wheel deployment mechanism, the wheel deployment mechanism configured deploy at least one deployable wheel from a non-support position to a support position, the deployable wheel being located in a wheeled region of the pallet; providing a pallet dolly configured so as to be deployable under at least a portion of the pallet, the dolly being detachably connectable to the pallet, the pallet dolly including a pallet lifting and support element and an actuation mechanism, the actuation mechanism configured to releasably engage and actuate the wheel deployment mechanism, thereby deploying the deployable wheel to a support position, the pallet lifting and support element configured so as to lift and support a non-wheeled region of the pallet; deploying the dolly under the at least a portion of the pallet; actuating the wheel deployment mechanism, thereby deploying the deployable wheel, thus lifting and supporting the pallet at the wheeled region; and actuating the pallet lifting and support element, thereby lifting and supporting the pallet at the non-wheeled region; wherein the support of the pallet at the wheeled region and the non-wheel region substantially supports an entire the pallet; relocating the pallet as desired; de-actuating the wheel deployment mechanism, thereby lowering the pallet to the ground at the wheeled region of the pallet; de-actuating the pallet lifting and support element, thereby lowering the pallet to the ground at the non-wheeled region; and removing the dolly from under the pallet.

According to a further teaching of the present invention, the actuating is performed by varying a position of a dolly handle.

According to a further teaching of the present invention, the deploying the deployable wheel and lifting and supporting the non-wheeled region of the pallet are performed substantially simultaneously.

According to a further teaching of the present invention, the wheel deployment mechanism is implemented as a mechanically actuated mechanism.

According to a further teaching of the present invention, the wheel deployment mechanism is implemented as a hydraulically actuated mechanism.

### BRIEF DESCRIPTION OF THE DRAWINGS

The invention is herein described, by way of example only, with reference to the accompanying drawings, wherein:

FIG. 1 is an isometric view of a pallet system constructed and operative according to the teachings of the present invention, which uses a mechanical wheel-deployment actuator, shown here, the dolly is deployed separate from the pallet;

FIG. 2 is an isometric view of the pallet system of FIG. 1, here the dolly is deployed under the pallet;

FIG. 3 is a top elevation of the pallet system of FIG. 1 with the dolly deployed under the pallet which is resting on the ground;

FIG. 4 is a cross-sectional side view along line A of FIG. 3;

FIG. 5 is a detail of area B of FIG. 4;

FIG. 6 is a detail of area C of FIG. 4;

FIG. 7 is a top elevation of the pallet system of FIG. 1 with the dolly deployed under the pallet which is being supported by the wheels of the dolly and the pallet wheels;

FIG. 8 is a cross-sectional side view along line D of FIG. 7;

FIG. 9 is a detail of area E of FIG. 8;

FIG. 10 is a detail of area F of FIG. 8;

FIG. 11 is an isometric view of a pallet system constructed and operative according to the teachings of the present invention, which uses a hydraulic wheel-deployment actuator, shown here, the dolly is deployed separate from the pallet;

FIG. 12 is an isometric view of the pallet system of FIG. 11, here the dolly is deployed under the pallet;

FIG. 13 is a top elevation of the pallet system of FIG. 11 with the dolly deployed under the pallet which is resting on the ground;

FIG. 14 is a cross-sectional side view along line G of FIG. 13;

FIG. 15 is a detail of area H of FIG. 14;

FIG. 16 is a detail of area I of FIG. 14;

FIG. 17 is a top elevation of the pallet system of FIG. 11 with the dolly deployed under the pallet which is being supported by the wheels of the dolly and the pallet wheels;

FIG. 18 is a cross-sectional side view along line J of FIG. 17;

FIG. 19 is a detail of area K of FIG. 18; and

FIG. 20 is a detail of area L of FIG. 18.

### DESCRIPTION OF THE PREFERRED EMBODIMENTS

The present invention is a pallet system that includes a plurality of deployable wheel pallets for use with a specialized pallet dolly.

The principles and operation of pallet system according to the present invention may be better understood with reference to the drawings and the accompanying description.

In addressing the needs of a market in which the size of standard shipping pallets is inappropriate, the present invention provides a unique solution to the issues of structural redundancy and size economy. Although the embodiments of the present invention discussed herein are born out of a need for a smaller more maneuverable pallet for use in commercial application where floor space is limited, this is not intended as a limitation. The principle of the present invention may be applied to pallets of any size be they standard, smaller or larger, and for use either commercially or non-commercially.

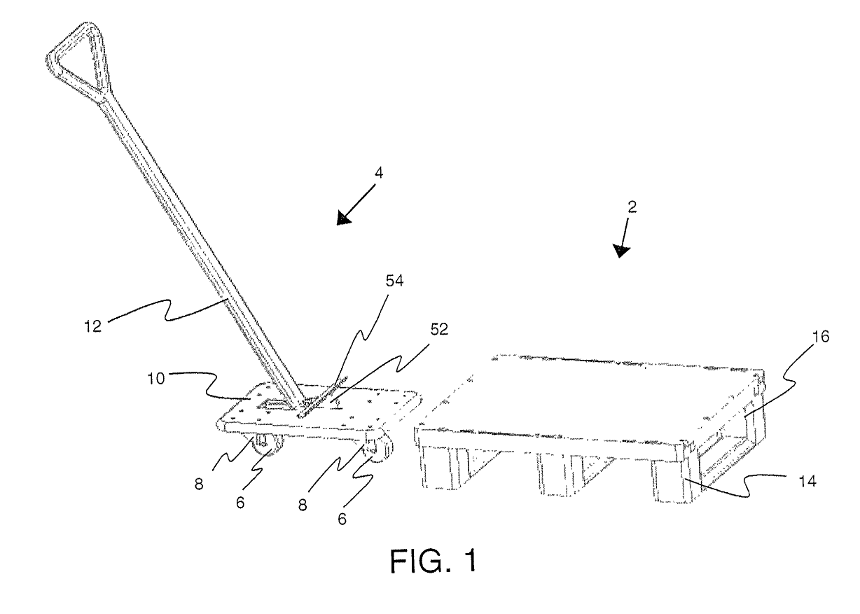

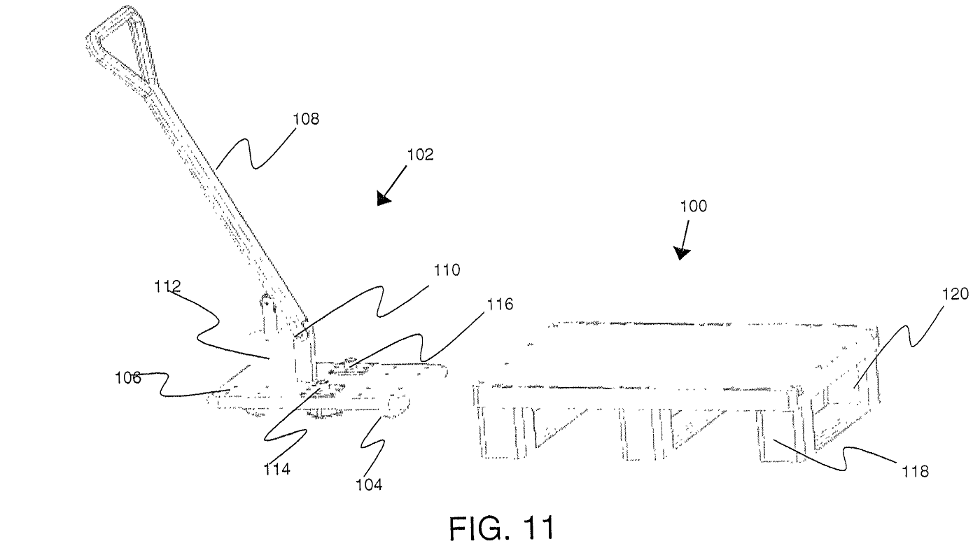

The discussion herein relates to two preferred embodiments of the present invention. A first embodiment (FIGS. 1-10) is implemented with substantially mechanical elements for raising the pallet and deploying the pallet wheels. A second embodiment (FIGS. 11-20) is implemented with substantially hydraulic elements for raising the pallet and deploying the pallet wheels. This discussion is in no way intended to limit the scope of the present invention, but to provide enabled examples. Any pallet system that provides: a plurality of interchangeable pallets for use with any of at least one specialized pallet dollies, wherein the pallet includes at least one wheel or roller element (herein referred to as wheels) that can be deployed between a support and a non-support position; and a specialized dolly that includes a mechanism for actuating the deployment of the pallet wheels and a structure for elevating and supporting a non-wheeled end of the pallet, is with in the intention of the present invention. Further, while the dollies described herein are for manual relocation and include wheels that are mounted so as to swivel about a vertical axis, any combination of motorization and steerablity is with in the intention of the present invention.

It should be noted, that in some instances for the sake of clarity, the discussion below may refer to particular elements in the plural while giving only one reference number. Further references may be made to single elements when it is understood that the reference is to a plurality of like elements. This is especially the case with regard to cross-sectional views which illustrate only one of what may be a plurality of like elements.

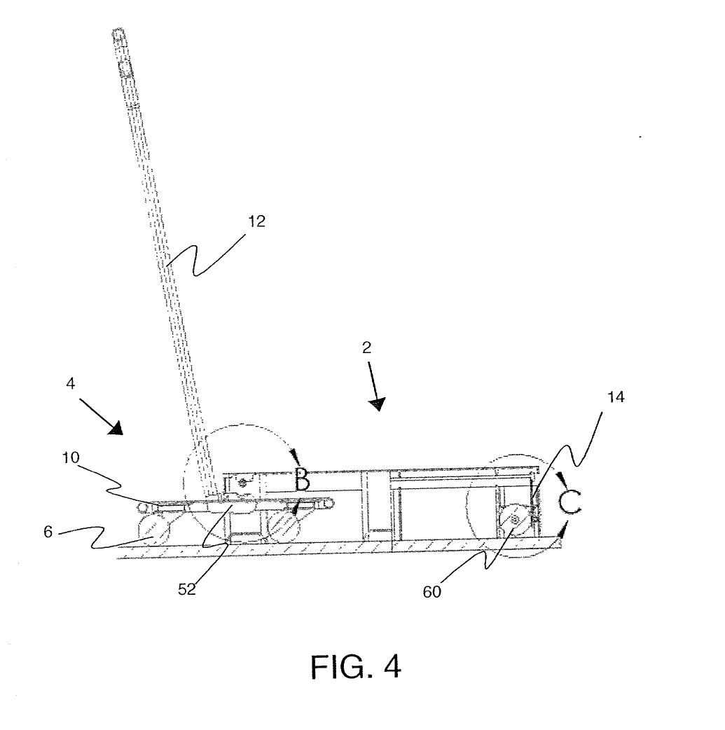

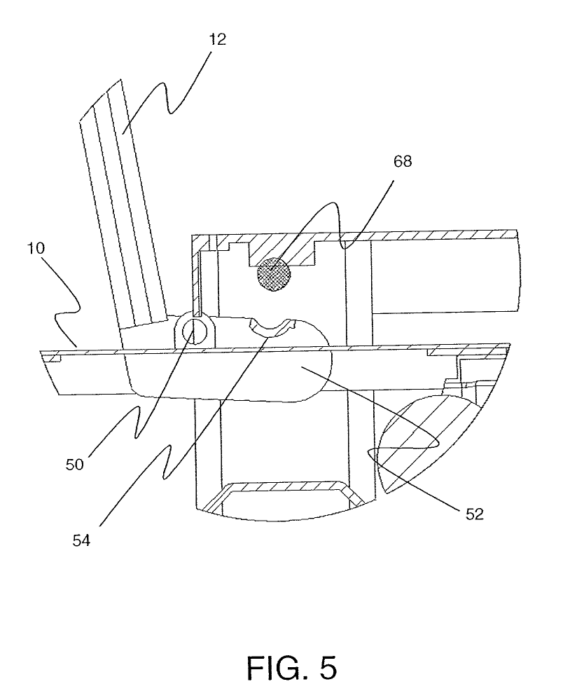

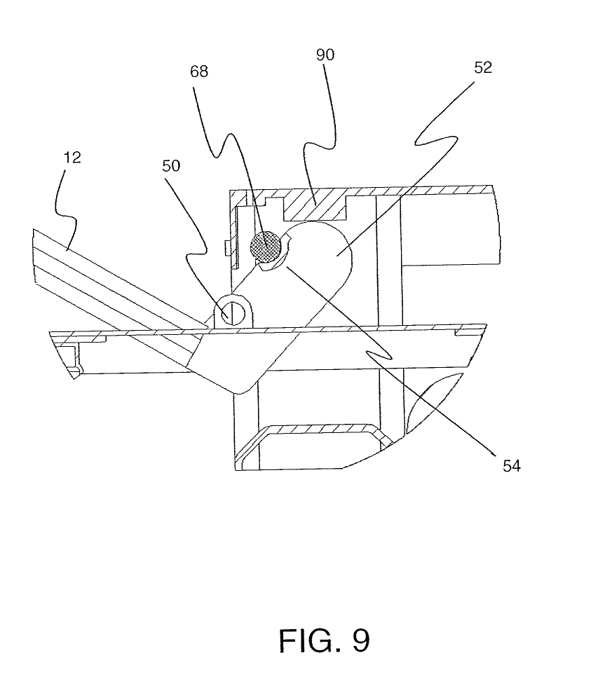

Referring now to the drawings, FIG. 1 shows a pallet 2 resting on the ground and a dolly 4. As used herein, the term dolly refers to any wheeled device that will support at least a portion of a pallet in such a way the pallet may be moved. While a dolly may have any number of wheel, to include as few as one, however, it is preferable for the dolly to be self-supporting and easily maneuverable, therefor three or four wheels seems most appropriate. The dolly shown here includes wheels 6 that are mounted to the dolly base 10 by use of swivel brackets 8. The dolly handle 12 acts as a lever that rotates about a axis 50 (FIG. 5) so as to raise and lower the pallet support 52 and the wheel-deployment engagement element 54, the functions of which will be discussed with regard to FIGS. 5 and 9. Of further interest are pallet support pillars 14 and 16, which house deployable wheel assemblies that will be discussed with regard to FIGS. 4, 6, 8, and 10.

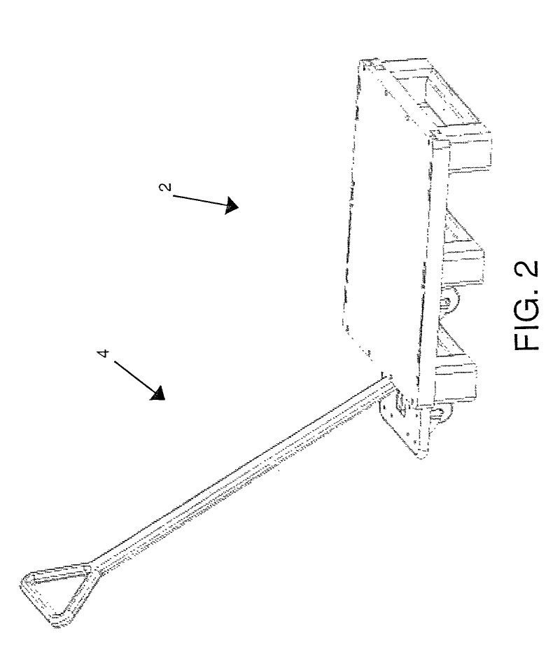

As shown in FIG. 2, the dolly 4 may be rolled under the pallet 2.

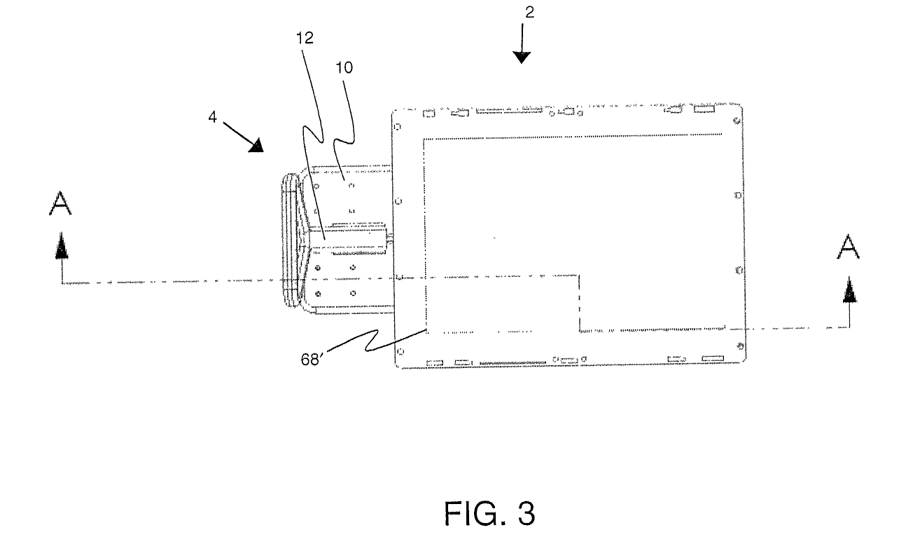

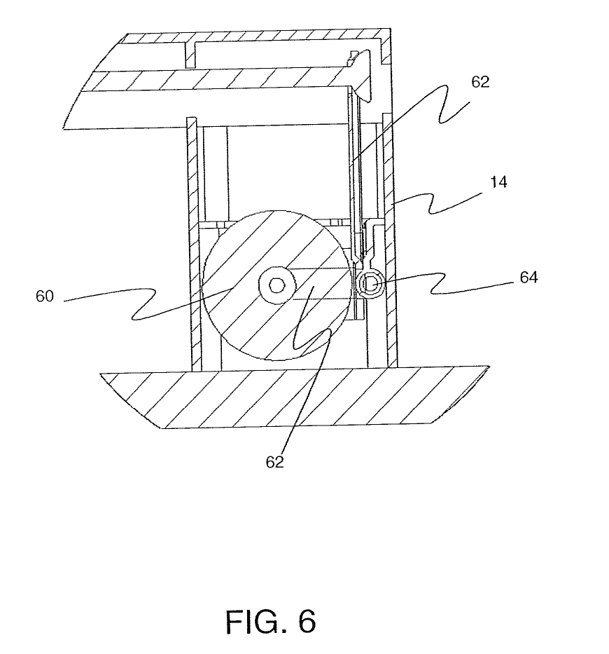

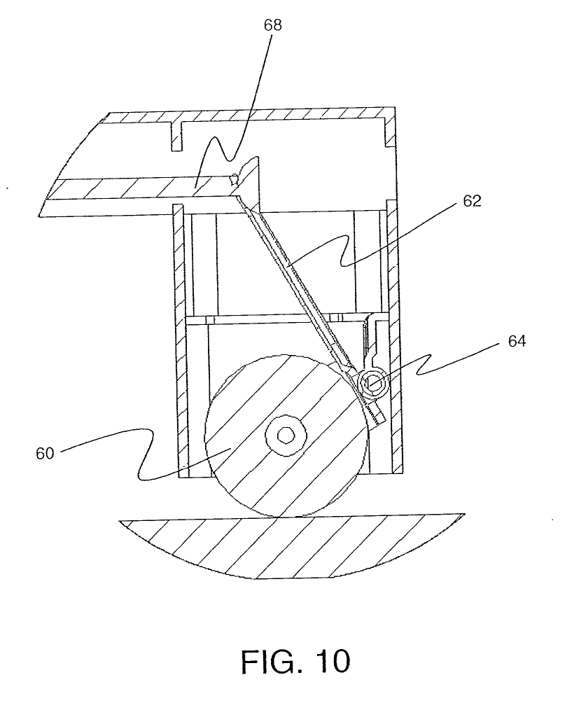

The top elevation of FIG. 3 is numbered in correspondence to FIG. 1, and serves to establish line A, along which the cross-sectional views of FIGS. 4, 5, and 6 are taken. Further, line 68′ shows the location of the mechanical wheel-deployment linkage 68 which is discussed with regard to FIGS. 6 and 10. It should be noted that any mechanical linkage whether rigid, such as, but not limited to, bars and rods, non-rigid, such as but not limited to, cables, chains, and belts, or any combination of rigid and non-rigid linkage are within the scope of the present invention. Further, the shape of the linkage as illustrated by line 68′, is intended to be just that, a non-limiting illustration of one possible implementation of a mechanical wheel-deployment linkage.

As seen in FIG. 4, the pallet wheels 60, which are located in pallet support pillars 14 and 16, do not contact the ground upon which the pallet is resting.

FIG. 5 shows the relative positions of the dolly handle 12, the dolly platform 10, the pallet support 52, the wheel-deployment engagement element 54, and the mechanical wheel-deployment linkage 68 before the pallet is raised.

FIG. 6 illustrates the elements of a mechanical wheel-deployment mechanism that are housed in each of the pallet support pillars 14 and 16. As shown here, the pallet wheel 60 is mounted on an “L” shaped wheel-deployment bracket 62 that rotates about an axle 64 located at the convergence of the two side of the “L”. Mechanical wheel-deployment linkage 68 extends the length of the pallet and engages the wheel-deployment engagement element 54 of the dolly.

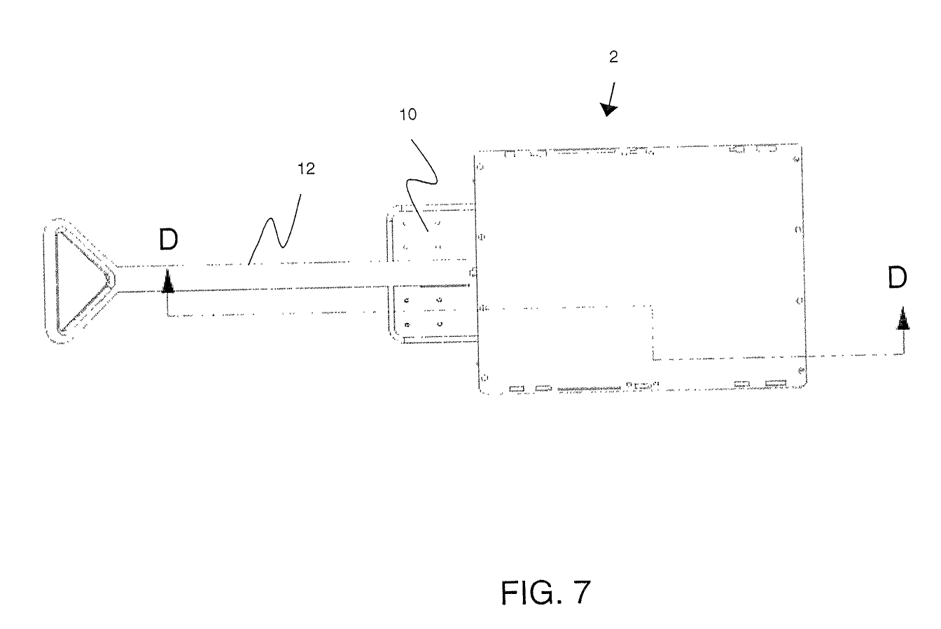

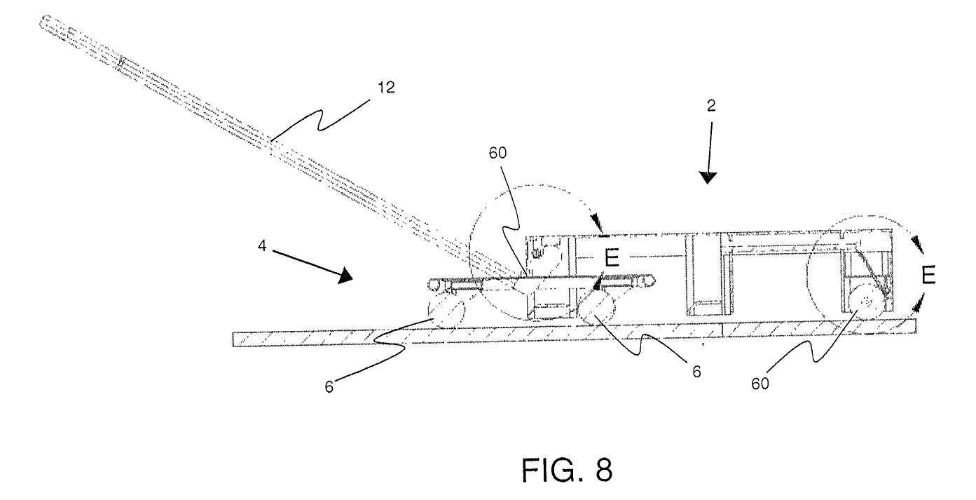

The top elevation of FIG. 7 is numbered in correspondence to FIG. 1, and serves to establish line D, along which the cross-sectional views of FIGS. 8, 9, and 10 are taken.

As illustrated in FIG. 8, the dolly handle 12 is lowered and the pallet 2 is supported at one by the dolly 4 and at the other end by the pallet wheels 60 now extended from pallet support pillars. The rotation of the handle about axle 60, as seen in FIG. 9, brings the pallet support 52 into contact with the underside of the pallet frame 90. Although not seen here, the pallet support may also contact other abutment structures associated with the underside of the pallet so as to hole the dolly in place while the dolly and pallet are pushed or pulled from one place to another. Alternatively, the dolly may include additional structures that so as to engage the pallet and thereby maintain proper positioning during pushing or pulling procedures. This action of the handle also brings the wheel-deployment engagement element 54, into engagement with the mechanical wheel-deployment linkage 68, thereby pulling the mechanical wheel-deployment linkage 68 forward, and, as seen in FIG. 10. This causes the “L” shaped wheel-deployment bracket 62 to rotate about an axle 64, thereby deploying the pallet wheels to a mobile support position.

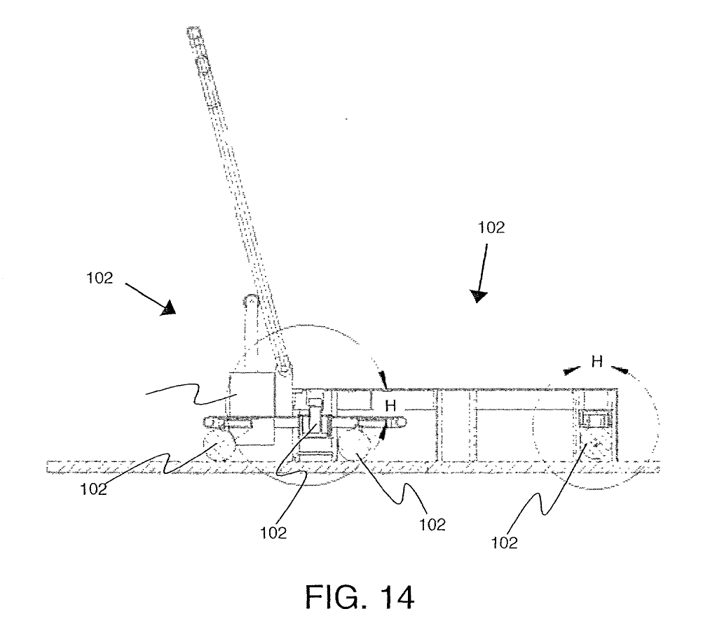

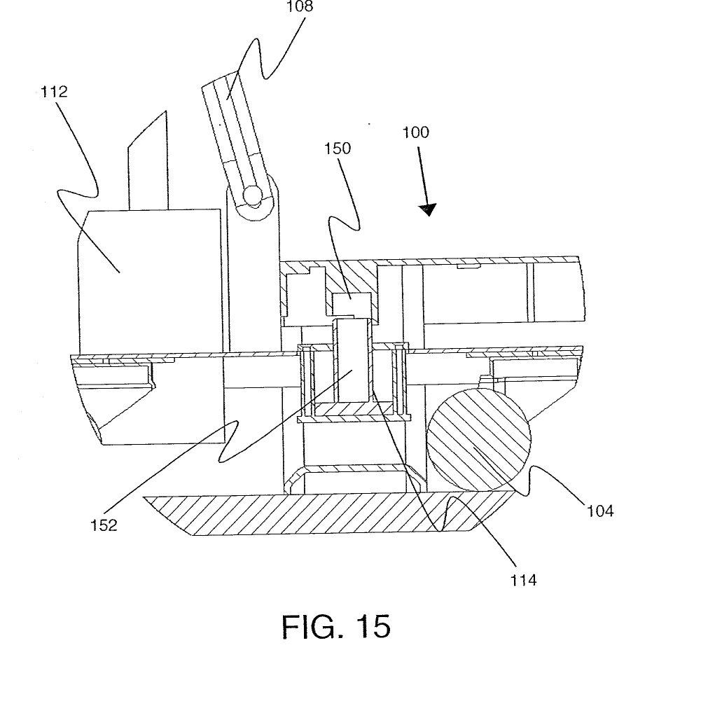

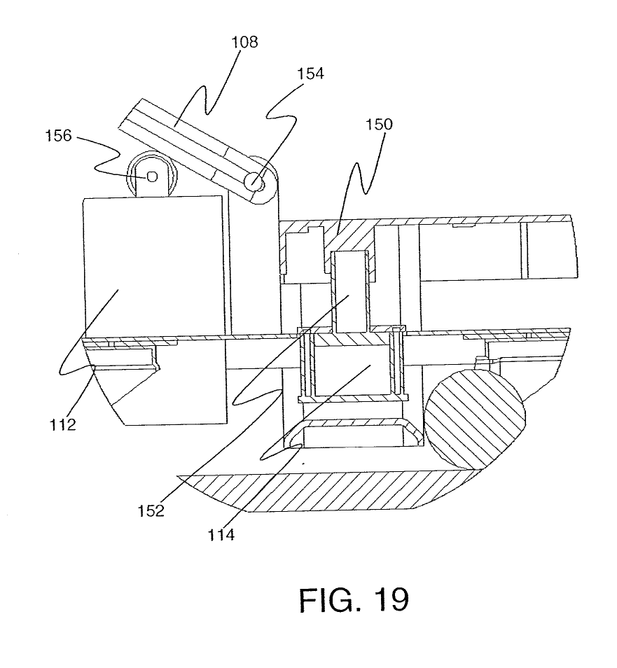

Turning now to a hydraulically actuated embodiment of the present invention, as illustrated in FIG. 11, the pallet system shown here includes a pallet 100 and a dolly 102. The term “hydraulic” as used herein is defined as any suitable working fluid, including gases. That is to say that this embodiment of the present invention may also be implemented as one that is pneumatically actuated. The dolly includes wheels 104 that are mounted to the dolly base 106 by use of swivel brackets (not visible here). The dolly handle 108 rotates about a axis 110 so as to actuate the hydraulic pump 112. The hydraulic pump is in fluid communication with, and activates, two hydraulic pallet support cylinder assemblies 114 and 116, the functions of which will be discussed with regard to FIGS. 15 and 19. Of further interest are pallet support pillars 118 and 120, which house deployable wheel assemblies that will be discussed with regard to FIGS. 14, 16, 18, and 20.

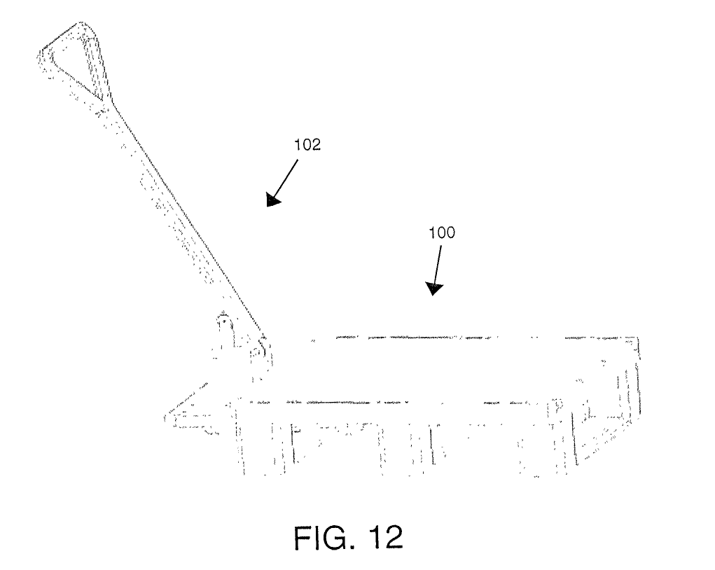

As shown in FIG. 12, the dolly 102 may be rolled under the pallet 100.

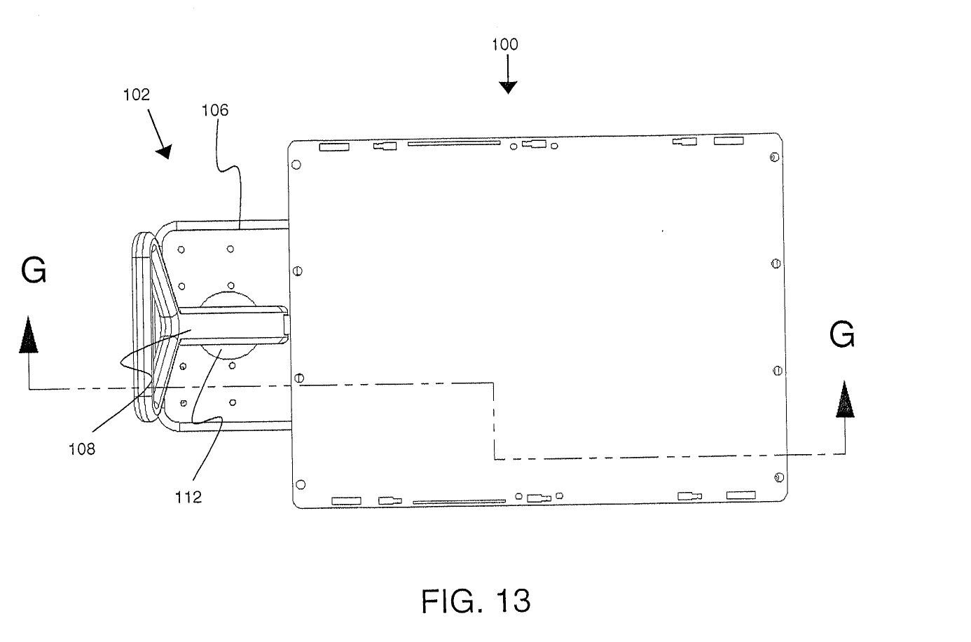

The top elevation of FIG. 13 is numbered in correspondence to FIG. 11, and serves to establish line G, along which the cross-sectional views of FIGS. 14, 15 and 16 are taken.

As seen in FIG. 14, the pallet wheels 160, which are located in pallet support pillars 118 and 120, do not contact the ground upon which the pallet is resting.

FIG. 15 shows the relative positions of the dolly handle 108, the dolly platform 106, the hydraulic pallet support cylinder 114, now seen to include the pallet support piston 152, and the hydraulic wheel-deployment linkage 150 before the pallet is raised.

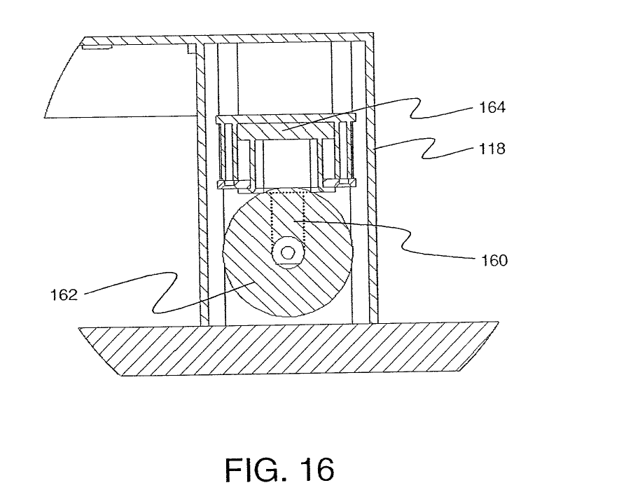

FIG. 16 illustrates the elements of a hydraulic wheel-deployment mechanism that are housed in each of the pallet support pillars 118 and 120. As shown here, the pallet wheel 160 is mounted on a wheel-deployment bracket 162 that extends from the hydraulic wheel-deployment piston and cylinder assembly 164. The hydraulic wheel-deployment piston and cylinder assembly is in fluid communication with the hydraulic wheel-deployment linkage 150 (FIG. 15).

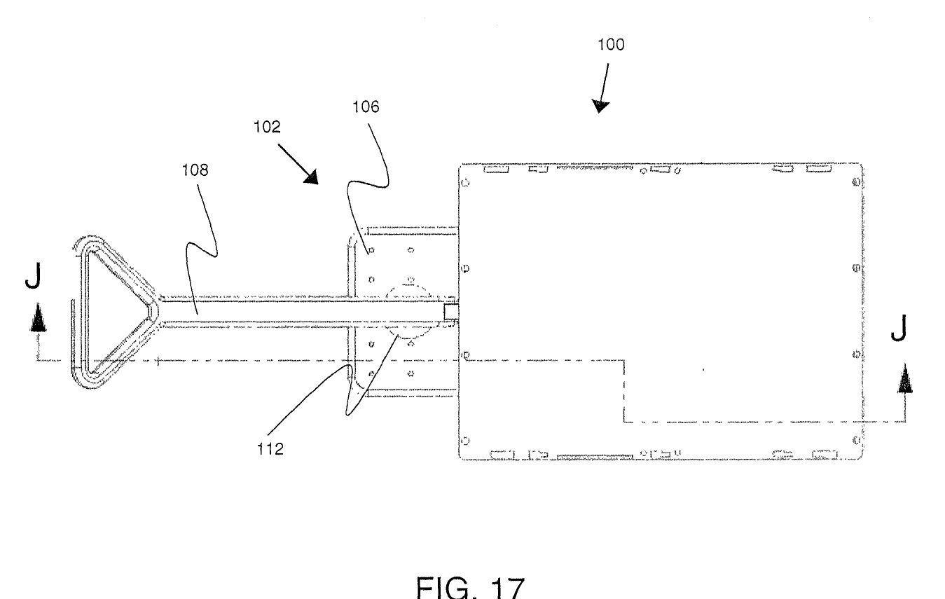

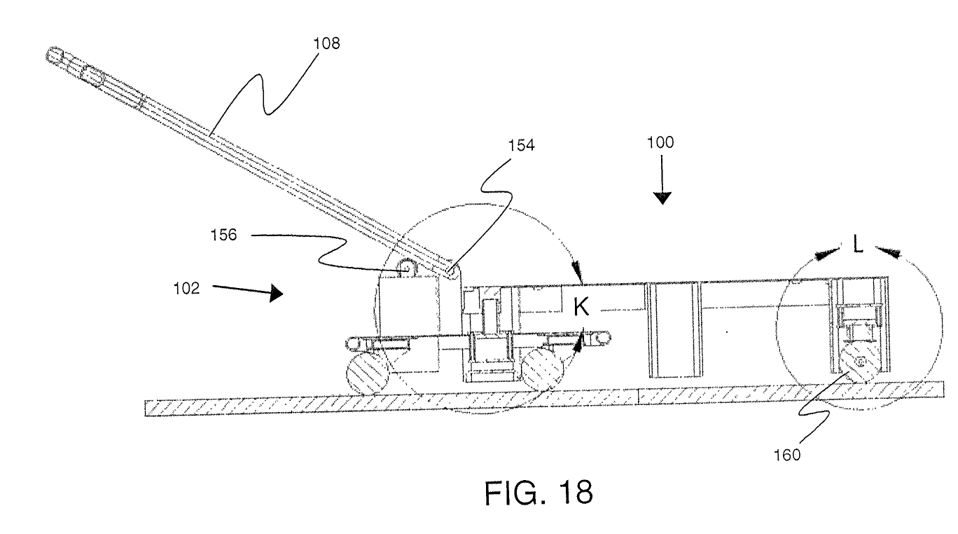

The top elevation of FIG. 17 is numbered in correspondence to FIG. 11, and serves to establish line J, along which the cross-sectional views of FIGS. 18, 19, and 20 are taken.

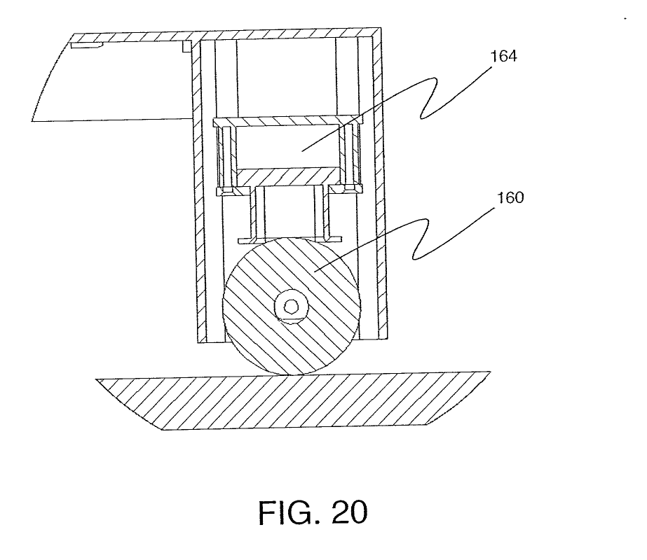

As illustrated in FIG. 18, the dolly handle 108 is lowered and the pallet 100 is supported at one by the dolly 102 and at the other end by the pallet wheels 160 located in the pallet support pillars. The rotation of the handle 108 about the axle 154,as seen in FIG. 19, actuates the hydraulic pump 112 by pressing on the pump plunger 156. This action causes the pallet support pistons 152 to extend, thereby contacting the hydraulic wheel-deployment linkage 150 and raising the pallet off the ground. The hydraulic wheel-deployment linkage 150 actuates the hydraulic wheel-deployment piston and cylinder assembly 164, thereby deploying the pallet wheels 160 to a mobile support position, as seen in FIG. 20. As illustrated, it is intended that both ends of the pallet are raised simultaneously, however, this need not be the case, and any process that lifts and supports the pallet off the ground is within the intention of the present invention. The hydraulic wheel-deployment linkage 150 may operate in any of several ways know in the art, such as, but not limited to:

1) corresponding elements of a hydraulic quick-connect assembly located one on a hydraulic supply line extending from the pallet support piston 152 and the other on the hydraulic wheel-deployment linkage 150, such that fluid communication is established between the hydraulic pump and the hydraulic wheel-deployment piston and cylinder assembly 164 when the pallet support piston is raised; and

2) a hydraulic piston and cylinder assembly, which in fluid communication with the hydraulic wheel-deployment piston and cylinder assembly 164, being located in the hydraulic wheel-deployment linkage 150 such that raising the pallet support piston pressurizes the fluid in the cylinder, whereby equalization of the pressure results in the extension of the piston of the hydraulic wheel-deployment piston and cylinder assembly 164, thereby deploying the pallet wheels 160.

It should be further noted, that while the examples discussed herein have employed mechanical and hydraulic actuators for raising deploying the pallet wheels and raising and lowering the pallet, any devices or actuators capable of performing the required actions are within the intentions of the present invention. Other non-limiting examples include, electric motors, electromagnetic devices, compressed air, and gear systems powered by any number of devices known in the art.

It will be appreciated that the above descriptions are intended only to serve as examples, and that many other embodiments are possible within the spirit and the scope of the present invention.

What is claimed is:

1. A pallet system for relocating any of at least one of interchangeable pallets by use of a specialized pallet dolly, the system comprising:
(a) at least one pallet that includes a wheel deployment mechanism, said wheel deployment mechanism configured to deploy at least one deployable wheel from a non-support position to a support position, said deployable wheel being located in a wheeled region of said pallet; and
(b) at least one pallet dolly configured so as to be deployable under at least a portion of said pallet, said dolly being detachably connectable to said pallet, said pallet dolly including a pallet lifting and support element and an actuation mechanism, said actuation mechanism configured to releasably engage and actuate said wheel deployment mechanism, thereby deploying said deployable wheel to a support position, said pallet lifting and support element configured so as to lift and support a non-wheeled region of said pallet;
wherein once so deployed, said pallet is supported by wheels and may then be re-located as necessary, the deployable wheel returned to a non-support position, said pallet lifting and support element disengaged from said pallet, and said dolly disengaged from said wheel deployment mechanism, thereby allowing redeployment of said dolly for use with another such pallet.

2. The pallet system of claim 1, wherein said actuation mechanism is configured to be activated by varying a position of a dolly handle.

3. The pallet system of claim 17 wherein said wheel deployment mechanism and said pallet lifting and support element are configured to be activated by a single activating element such that respective portions of said pallet are raised simultaneously.

4. The pallet system of claim 1, wherein said wheel deployment mechanism is mechanical.

5. The pallet system of claim 1, wherein said wheel deployment mechanism is hydraulic.

6. The pallet system of claim 1, wherein said pallet is formed of polymer materials.

7. A method for relocating a pallet, the method comprising:
(a) providing a pallet that includes a wheel deployment mechanism, said wheel deployment mechanism configured deploy at least one deployable wheel from a non-support position to a support position, said deployable wheel being located in a wheeled region of said pallet;
(b) providing a pallet dolly configured so as to be deployable under at least a portion of said pallet, said dolly being detachably connectable to said pallet, said pallet dolly including a pallet lifting and support element and an actuation mechanism, said actuation mechanism configured to releasably engage and actuate said wheel deployment mechanism, thereby deploying said deployable wheel to a support position, said pallet lifting and support element configured so as to lift and support a non-wheeled region of said pallet;
(c) deploying said dolly under said at least a portion of said pallet;
(d) actuating said wheel deployment mechanism, thereby deploying said deployable wheel, thus lifting and supporting said pallet at said wheeled region; and
(e) actuating said pallet lifting and support element, thereby lifting and supporting said pallet at said non-wheeled region;
wherein said support of said pallet at said wheeled region and said non-wheel region substantially supports an entire said pallet;
(f) relocating said pallet as desired;
(g) de-actuating said wheel deployment mechanism, thereby lowering said pallet to the ground at said wheeled region of said pallet;
(h) de-actuating said pallet lifting and support element, thereby lowering said pallet to the ground at said non-wheeled region; and
(i) removing said dolly from under said pallet.

8. The method of claim 7, wherein said actuating is performed by varying a position of a dolly handle.

9. The method of claim 7, wherein said deploying said deployable wheel and lifting and supporting said non-wheeled region of said pallet are performed substantially simultaneously.

10. The method of claim 7, wherein said wheel deployment mechanism is implemented as a mechanically actuated mechanism.

11. The method of claim 7, wherein said wheel deployment mechanism is implemented as a hydraulically actuated mechanism.
